(19) United States
(12) Patent Application Publication
(10) Pub. No.: US 2018/0230565 A1
(43) Pub. Date: Aug. 16, 2018

(54) GRAIN-ORIENTED ELECTRICAL STEEL SHEET AND MANUFACTURING METHOD THEREFOR

(71) Applicant: JFE STEEL CORPORATION, Chiyoda-ku, Tokyo (JP)

(72) Inventors: Makoto WATANABE, Chiyoda-ku, Tokyo (JP); Toshito TAKAMIYA, Chiyoda-ku, Tokyo (JP); Ryuichi SUEHIRO, Chiyoda-ku, Tokyo (JP); Takashi TERASHIMA, Chiyoda-ku, Tokyo (JP)

(73) Assignee: JFE STEEL CORPORATION, Chiyoda-ku, Tokyo (JP)

(21) Appl. No.: 15/750,264

(22) PCT Filed: Sep. 21, 2016
(86) PCT No.: PCT/JP2016/004311

§ 371 Date: Feb. 5, 2018

(30) Foreign Application Priority Data
Sep. 25, 2015 (JP) 2015-188671

(51) Int. Cl. C21D 8/12; C23C 22/33; C21D 9/46; H01F 1/18

(52) U.S. Cl. CPC C21D 8/1283; H01F 1/18; C21D 9/46; C23C 22/33

(57) ABSTRACT

A grain-oriented electrical steel sheet has a coating on a surface thereof. The coating has a composite elastic modulus of 60 GPa to 95 GPa and a film thickness of 1.0 μm or more, and a tension applied to the grain-oriented electrical steel sheet by the coating is 6.0 MPa or more, and an amount of iron loss degradation between before and after roll reduction when the grain-oriented electrical steel sheet is roll-reduced at a linear pressure of 68.6 N/cm is 0.010 W/kg or less in W_{17/50}.

### TECHNICAL FIELD

The present disclosure relates to a grain-oriented electrical steel sheet that can be prevented from degradation in magnetic property when processed into a transformer, and a manufacturing method therefor.

### BACKGROUND

A grain-oriented electrical steel sheet is typically provided with a surface coating (hereafter also referred to as “coating”), to impart insulation property, workability, rust resistance, and the like. Such a coating is, for example, a phosphate-based top coating formed on a base film mainly made of forsterite and formed during final annealing in a grain-oriented electrical steel sheet manufacturing process.

The coating is formed at high temperature, and has a low coefficient of thermal (heat) expansion. The coating therefore has an effect of applying tension to the steel sheet and reducing iron loss by the difference in coefficient of thermal expansion between the steel sheet (base steel sheet) and the coating, when the temperature is decreased to ambient temperature after the formation.

The grain-oriented electrical steel sheet is also needed to satisfy other various required properties such as corrosion resistance and voltage endurance. Various coatings have been conventionally proposed to satisfy such various required properties.

For example, JP S56-52117 B2 (PTL 1) discloses a coating formed by applying a coating solution mainly made of magnesium phosphate, colloidal silica, and chromic anhydride to a steel sheet surface and baking the applied coating solution. JP S53-28375 B2 (PTL 2) discloses a coating formed by applying a coating solution mainly made of aluminum phosphate, colloidal silica, and chromic anhydride to a steel sheet surface and baking the applied coating solution.

### CITATION LIST

### Patent Literatures

PTL 1: JP S56-52117 B2

PTL 2: JP S53-28375 B2

PTL 3: JP 3324633 B2

PTL 4: JP H9-184017 A

PTL 5: JP 5104128 B2

### SUMMARY

### Technical Problem

However, the grain-oriented electrical steel sheet provided with any of the coatings described in PTL 1 and PTL 2 has a problem of degrading in iron loss when processed into an iron core of a transformer.

As a method for improving iron loss, for example, JP 3324633 B2 (PTL 3) discloses a method of applying higher film tension to a steel sheet to improve iron loss, and JP H9-184017 A (PTL 4) discloses a method of minimizing precipitates in a steel sheet to prevent iron loss degradation caused by stress relief annealing.

The methods described in PTL 3 and PTL 4, however, cannot suppress the above-mentioned iron loss degradation when processing the steel sheet into an iron core of a transformer. There is thus a need to effectively suppress iron loss degradation when processing the grain-oriented electrical steel sheet into an iron core of a transformer.

It could be helpful to provide a grain-oriented electrical steel sheet that can be prevented from degradation in magnetic property and in particular iron loss when processed into an iron core of a transformer, and an advantageous manufacturing method therefor.

### Solution to Problem

We conducted keen examination.

First, we researched and examined why the iron loss of a grain-oriented electrical steel sheet degrades significantly when the grain-oriented electrical steel sheet is processed into an iron core of a transformer.

We consequently discovered that a main cause of the iron loss degradation is processing strain generated by roll-reducing the grain-oriented electrical steel sheet by measuring rolls.

In detail, in the case of processing the grain-oriented electrical steel sheet into an iron core of a transformer, the strip coil (steel sheet) is passed through rolls for length measurement called measuring rolls, and then cut to a specific length by a shearing machine. Cut portions of the steel sheet are overlapped to form an iron core of a transformer. Here, if the diameter of the measuring rolls changes due to pressure, the measured length becomes imprecise. Accordingly, hard rolls made of metal are used as the measuring rolls. Moreover, if a slip occurs between the steel sheet and the measuring rolls, the measured length becomes imprecise. To prevent such imprecise length measurement, the strip coil is roll-reduced by the measuring rolls with a strong pressing force. This can cause processing strain to be introduced into the strip coil during the strip coil length measurement by the measuring rolls. Due to such processing strain, the magnetic property and in particular the iron loss degrades.

To prevent iron loss degradation caused by the introduction of processing strain, we further conducted examination.

We consequently discovered that, by appropriately controlling the properties of a coating baked and formed on the surface of the grain-oriented electrical steel sheet and in particular the composite elastic modulus and film thickness of the coating and the tension applied to the steel sheet by the coating, the introduction of processing strain into the steel sheet can be suppressed to effectively prevent iron loss degradation even when the steel sheet is strongly roll-reduced by the measuring rolls or the like.

The present disclosure is based on these discoveries and further studies.

We thus provide:

1. A grain-oriented electrical steel sheet having a coating on a surface thereof, wherein the coating has a composite elastic modulus of 60 GPa to 95 GPa and a film thickness of 1.0 μm or more, and a tension applied to the grain-oriented electrical steel sheet by the coating is 6.0 MPa or more, and an amount of iron loss degradation between before and after roll reduction when the grain-oriented electrical steel sheet is roll-reduced at a linear pressure of 68.6 N/cm is 0.010 W/kg or less in W_{17/50}.

2. A manufacturing method for the grain-oriented electrical steel sheet according to 1., the manufacturing method comprising: applying a coating solution to a final-annealed grain-oriented electrical steel sheet; and performing flattening annealing that also serves as coating baking, on the final-annealed grain-oriented electrical steel sheet to which the coating solution is applied, wherein the coating solution contains at least one phosphate selected from phosphates of Mg, Al, Ca, and Sr, and contains 50 parts to 150 parts by mass of colloidal silica in terms of solid content with respect to 100 parts by mass of the phosphate, and in the flattening annealing, a soaking temperature is set to 750° C. to 900° C., a residence time in a temperature range of 750° C. or more is set to 1 sec to 30 sec, and an atmosphere in the temperature range is set to an inert atmosphere with a dew point of 0° C. or less.

3. The manufacturing method according to 2., wherein the coating solution further contains 10 parts to 50 parts by mass in total of at least one additive selected from a titanium compound, a manganese sulfate, and an oxide colloid in terms of solid content, with respect to 100 parts by mass of the phosphate.

4. The manufacturing method according to 2., wherein the coating solution further contains 10 parts to 50 parts by mass of chromic anhydride in terms of solid content or 10 parts to 50 parts by mass in total of at least one dichromate selected from dichromates of Mg, Ca, Al, and Sr in terms of solid content, with respect to 100 parts by mass of the phosphate.

### Advantageous Effect

It is thus possible to effectively prevent iron loss degradation when processing a grain-oriented electrical steel sheet into an iron core of a transformer. Hence, excellent iron loss property based on the property of the grain-oriented electrical steel sheet before processing can be obtained in an actual transformer

### BRIEF DESCRIPTION OF THE DRAWINGS

In the accompanying drawings:

FIG. 1 is a diagram illustrating the relationship between the residence time in the temperature range of 750° C. or more in flattening annealing and the amount of iron loss degradation between before and after roll reduction;

FIG. 2A is a diagram illustrating the relationship between the residence time in the temperature range of 750° C. or more in flattening annealing and the composite elastic modulus of the coating; and

FIG. 2B is a diagram illustrating the relationship between the residence time in the temperature range of 750° C. or more in flattening annealing and the applied tension of the coating.

### DETAILED DESCRIPTION

One of the disclosed embodiments is described in detail below.

As mentioned above, the present disclosure is based on the discoveries that, by appropriately controlling the properties of a coating provided on the surface of a grain-oriented electrical steel sheet and in particular the composite elastic modulus, the film thickness, and the tension applied to the steel sheet, the introduction of processing strain into the steel sheet can be suppressed to effectively prevent iron loss degradation even when the steel sheet is strongly roll-reduced by the measuring rolls or the like.

Experiments that led to these discoveries are described first.

A final-annealed grain-oriented electrical steel sheet was sheared into samples with a size of 300 mm in length×100 mm in width, and pickled with phosphoric acid. After this, a coating solution containing 100 parts by mass of colloidal silica and 50 parts by mass of titanium lactate which is a titanium compound in terms of solid content with respect to 100 parts by mass of magnesium phosphate was applied to both sides of each sample so that the coating amount per both sides after drying was 6 g/m² to 14 g/m². These samples were then subjected to flattening annealing also serving as coating baking. The flattening annealing was performed in a dry N₂ atmosphere at a soaking temperature of 800° C., with the residence time in the temperature range of 750° C. or more being varied in the range of 0.5 sec to 35 sec. As a result of observing their coating sections after the baking using an optical microscope, the respective film thicknesses were 0.8 μm, 1.2 μm, and 2.3 μm.

The obtained samples were submitted to magnetic property measurement by a single sheet tester (hereafter also referred to as “SST method”). Subsequently, the full width of each sample was roll-reduced at a linear pressure of 68.6 N/cm (7 kgf/cm) by measuring rolls of 100 mm in width. The sample was then submitted again to the magnetic property measurement by the SST method, and the iron loss difference ΔW_{17/50} between before and after the roll reduction (or the amount of iron loss degradation between before and after the roll reduction) was calculated.

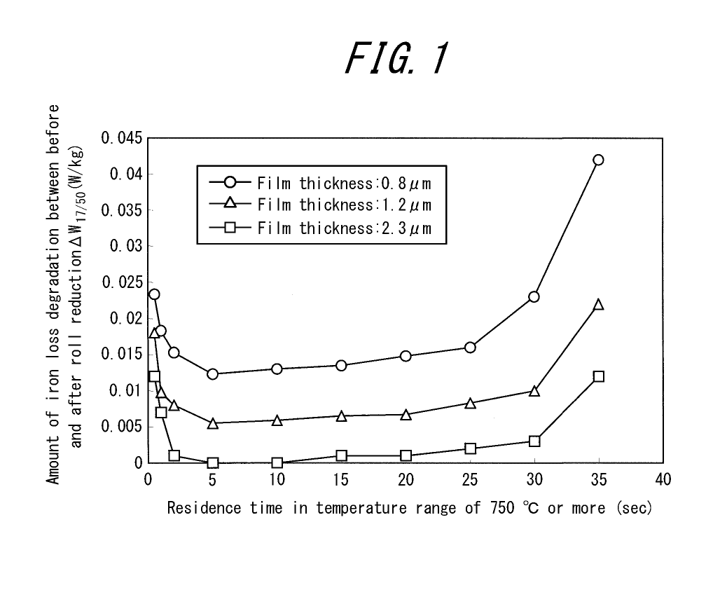

FIG. 1 illustrates the relationship between the residence time in the temperature range of 750° C. or more in the flattening annealing and the amount of iron loss degradation between before and after the roll reduction.

As illustrated in FIG. 1, regardless of the coating film thickness, the amount of iron loss degradation between before and after the roll reduction increased if the residence time in the temperature range of 750° C. or more in the flattening annealing was excessively long or excessively short. If the residence time in the temperature range of 750° C. or more was 1 sec to 30 sec, on the other hand, the amount of iron loss degradation between before and after the roll reduction was small, and iron loss degradation was effectively suppressed.

To investigate the cause of the results in FIG. 1, we measured various physical properties of each type of sample. First, the composite elastic modulus of the coating was measured by a nanoindentation method.

Moreover, for each sample produced separately, the coating on one side was removed and the magnitude of deflection of the steel sheet was measured, to determine the tension applied to the steel sheet by the coating (hereafter also simply referred to as “applied tension of coating”).

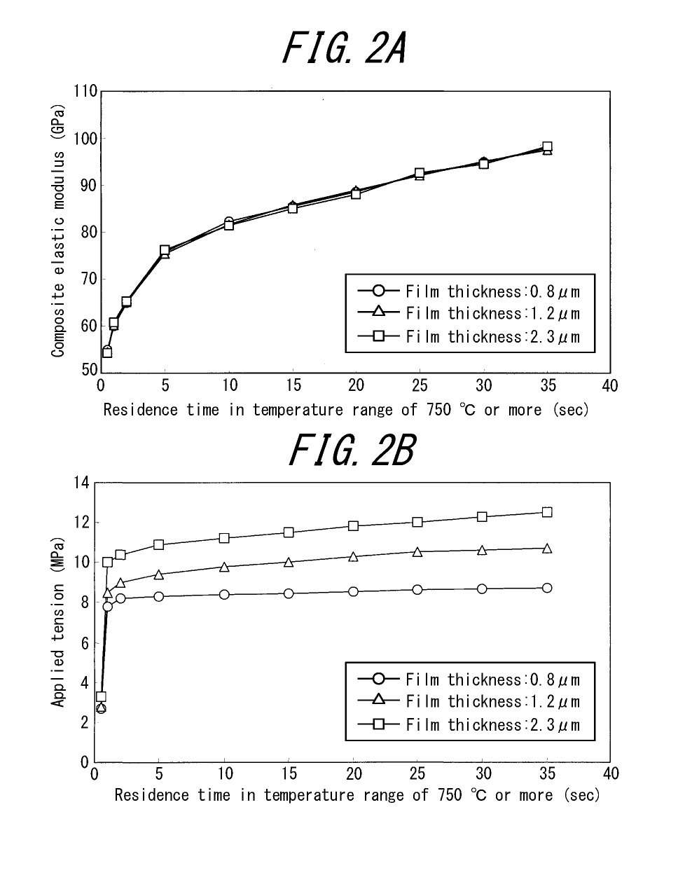

FIG. 2A illustrates the relationship between the residence time in the temperature range of 750° C. or more in the flattening annealing and the composite elastic modulus of the coating. FIG. 2B illustrates the relationship between the residence time in the temperature range of 750° C. or more in the flattening annealing and the applied tension of the coating.

As illustrated in FIG. 2A, when the residence time in the temperature range of 750° C. or more in the flattening annealing was longer, the composite elastic modulus of the coating was higher. As illustrated in FIG. 2B, when the residence time in the temperature range of 750° C. or more in the flattening annealing was longer, the applied tension of the coating was higher.

From these results, we studied why the amount of iron loss degradation between before and after the roll reduction was reduced by limiting the residence time in the temperature range of 750° C. or more in the flattening annealing to the predetermined range.

In a typical grain-oriented electrical steel sheet manufacturing process, the flattening annealing also serves as the coating baking, and the flattening annealing temperature corresponds to the coating baking temperature. It has conventionally been assumed that, if a coating is baked in the temperature range from the glass transition point of the coating to the crystallization point of the coating (most insulation coatings for grain-oriented electrical steel sheets have a glass transition point of 750° C. or more and a crystallization point of 900° C. or more), a coating with adequate quality is obtained. It has thus been assumed that, if the coating is baked in this temperature range, the quality of the coating does not depend on the baking time. However, it has become clear that, even in the case of baking the coating at the same soaking temperature, the properties of the coating change depending on the baking time and in particular the residence time in the temperature range of 750° C. or more, as mentioned above. This is considered to be because the fine bond structure of the coating is strengthened during the coating baking.

In glass, e.g. SiO₂, Si and oxygen form a network structure having an irregular three-dimensional skeleton in the form of —Si—O—Si—. However, for example some part bonds with H as

. . . —Si—O—H,H—O—Si— . . .

or bonds with impurity Na as

. . . —Si—O—Na,Na—O—Si— . . .

so that a part where the bond is broken is present. The presence of such non-bridging oxygen causes a decrease in the elastic modulus of glass.

By increasing the baking time and in particular the residence time in the temperature range of 750° C. or more, however, such non-bridging parts disappear and a firm glass structure forms, as a result of which the composite elastic modulus of the coating increases. Especially in the case where the residence time in the temperature range of 750° C. or more in the flattening annealing increases and the composite elastic modulus of the coating exceeds 95 GPa, if strong stress is applied to the coating by roll reduction with the measuring rolls or the like, the stress cannot be sufficiently absorbed within the coating, and strong stress acts on the steel substrate portion. This causes plastic deformation of the steel sheet, and leads to significant iron loss degradation between before and after the roll reduction.

If the composite elastic modulus of the coating is excessively low, on the other hand, the coating deforms easily, and as a result the stress by the roll reduction cannot be absorbed sufficiently. This also leads to iron loss degradation between before and after the roll reduction.

Moreover, with a coating film thickness of 1.0 μm or more, plastic deformation of the steel sheet can be effectively prevented and iron loss degradation can be suppressed, as illustrated in FIG. 1.

Based on these experimental results and study results, the grain-oriented electrical steel sheet according to the present disclosure has a coating with a composite elastic modulus of 60 GPa to 95 GPa, a film thickness of 1.0 μm or more, and an applied tension of 6.0 MPa or more formed on its surface.

The coating of the grain-oriented electrical steel sheet according to the present disclosure is described below.

The coating mentioned here is typically composed of a phosphate-based top coating formed on a base film mainly made of forsterite. In the case where a base film mainly made of forsterite is removed or is not formed, however, a phosphate-based top coating is formed on the steel substrate of the steel sheet.

Composite elastic modulus of coating: 60 GPa to 95 GPa

If the composite elastic modulus of the coating is less than 60 GPa, the applied tension of the coating decreases. This not only degrades iron loss in the grain-oriented electrical steel sheet before the roll reduction, but also increases iron loss degradation between before and after the roll reduction. If the composite elastic modulus of the coating is more than 95 GPa, the stress sensitivity of the steel sheet increases, leading to significant iron loss degradation between before and after the roll reduction. The composite elastic modulus of the coating is therefore in the range of 60 GPa to 95 GPa. The composite elastic modulus of the coating is preferably 65 GPa or more. The composite elastic modulus of the coating is preferably 90 GPa or less. The composite elastic modulus of the coating is more preferably 70 GPa or more. The composite elastic modulus of the coating is more preferably 90 GPa or less.

The composite elastic modulus mentioned here is the average value of the composite elastic modulus measured by a nanoindentation method in the following manner: The coating on the steel sheet surface is indented using a diamond-made indenter of a triangular pyramid (Berkovich type, vertex angle: 60°) at any three locations with a loading time of 5 sec, an unloading time of 2 sec, and a maximum load of 1000 μN, in a linear load application mode at ambient temperature.

The nanoindentation method is a method of pressing an indenter into a sample, continuously measuring the load and the depth, and calculating the composite elastic modulus from the relationship of the indentation depth and the load. The nanoindentation method has a smaller indentation depth of an indenter than the micro-Vickers method, and so is usually used in physical property tests for thin films.

Film thickness of coating: 1.0 μm or more

If the film thickness of the coating is 1.0 μm or more, even in the case where strong stress acts on the steel sheet, plastic deformation of the steel sheet is effectively prevented to suppress iron loss degradation between before and after the roll reduction. The film thickness of the coating is therefore 1.0 μm or more. The film thickness of the coating is preferably 1.5 μm or more. No upper limit is placed on the film thickness of the coating, but the upper limit is typically about 3.5 μm. The film thickness of the coating mentioned here is the film thickness of the coating per one side.

Applied tension of coating: 6.0 MPa or more

If the applied tension of the coating is less than 6.0 MPa, not only the original iron loss degrades, but also the composite elastic modulus tends to decrease excessively. This leads to iron loss degradation between before and after the roll reduction. The applied tension of the coating is therefore 6.0 MPa or more. The applied tension of the coating is preferably 8.0 MPa or more. No upper limit is placed on the applied tension of the coating, but the upper limit is typically about 18.0 MPa.

The applied tension of the coating can be calculated from the magnitude of deflection of the steel sheet. The magnitude of deflection of the steel sheet can be obtained follows: The coating on one side is removed from the steel sheet on which the coating is formed on both sides. A sample of 280 mm in length and 30 mm in width is cut out in the rolling direction, and placed perpendicularly to the ground with its longitudinal direction being the horizontal direction and its transverse direction being the vertical direction. In a state where one rolling direction end of 30 mm is held and fixed, the displacement (mm) at the end opposite to the fixed end is set as the magnitude of deflection of the steel sheet.

From the magnitude of deflection of the steel sheet (displacement) obtained in this way, the applied tension of the coating can be calculated according to the following formula:

[applied tension of coating]=(Eta)/l²

where E is the Young's modulus of the steel sheet (sample), t is the sheet thickness (mm) of the steel sheet (sample), a is the displacement (mm), and l is the length (mm) of the steel sheet (sample) in the non-fixed portion (1:250 mm in the above-mentioned case).

By forming this coating on the steel sheet surface, the amount of iron loss degradation between before and after the roll reduction when the steel sheet is roll-reduced by the measuring rolls or the like can be reduced to 0.010 W/kg or less in W_{17/50}. Here, the coating is basically formed on both sides of the steel sheet.

The final-annealed grain-oriented electrical steel sheet on the surface of which the coating is formed is not limited to any particular steel type, and a final-annealed grain-oriented electrical steel sheet produced according to a conventional method may be used. The sheet thickness of the grain-oriented electrical steel sheet (not including the thickness of the coating) is typically about 0.15 mm to 0.50 mm.

A manufacturing method for a grain-oriented electrical steel sheet according to the present disclosure is described below.

The manufacturing method for a grain-oriented electrical steel sheet according to the present disclosure includes: applying a phosphate-based coating solution to a final-annealed grain-oriented electrical steel sheet; and performing flattening annealing that also serves as coating baking, on the final-annealed grain-oriented electrical steel sheet.

The manufacturing conditions of the final-annealed grain-oriented electrical steel sheet and the like are not limited. For example, the final-annealed grain-oriented electrical steel sheet can be manufactured as follows: A steel raw material is hot rolled by a known method, to obtain a hot rolled sheet. The hot rolled sheet is annealed and cold rolled one or more times to obtain a cold rolled sheet with a final sheet thickness. After this, the cold rolled sheet is subjected to primary recrystallization annealing. An annealing separator is then applied to the steel sheet, and the steel sheet is final-annealed.

The unreacted annealing separator is removed from the final-annealed grain-oriented electrical steel sheet by water washing, light pickling, or the like according to need, and then the coating solution is applied to the steel sheet.

The coating solution may be a conventionally known coating solution (e.g. a coating solution described in PTL 1, PTL 2, or JP 5104128 B2 (PTL 5)) as long as a coating obtained after baking has the above-mentioned properties. For example, a coating solution containing at least one phosphate selected from phosphates of Mg, Al, Ca, and Sr is suitable. In the case of using such a coating solution, if colloidal silica is less than 50 parts by mass in terms of solid content with respect to 100 parts by mass of the phosphate, the tension applied to the steel sheet decreases and the composite elastic modulus decreases, which might lead to iron loss degradation and especially iron loss degradation between before and after the roll reduction. If the colloidal silica is more than 150 parts by mass in terms of solid content with respect to 100 parts by mass of the phosphate, fine cracks appear on the coating surface, and the corrosion resistance decreases. Besides, the tension applied to the steel sheet decreases and the composite elastic modulus decreases, which might lead to iron loss degradation and especially iron loss degradation between before and after the roll reduction. Accordingly, in the case of using a coating solution containing at least one phosphate selected from phosphates of Mg, Al, Ca, and Sr, the colloidal silica is 50 parts to 150 parts by mass in terms of solid content with respect to 100 parts by mass of the phosphate. The colloidal silica is preferably 70 parts by mass or more. The colloidal silica is preferably 120 parts by mass or less.

In addition to these components, the coating solution may contain at least one additive selected from a titanium compound, a manganese sulfate, and an oxide colloid. Thus, the corrosion resistance can be improved while reducing environmental impact. In this case, if the additive is less than 10 parts by mass in terms of solid content with respect to 100 parts by mass of the phosphate, the corrosion resistance improving effect is low. Besides, the tension applied to the steel sheet decreases and the composite elastic modulus decreases, which might lead to iron loss degradation and especially iron loss degradation between before and after the roll reduction. If the additive is more than 50 parts by mass in terms of solid content with respect to 100 parts by mass of the phosphate, film formation is difficult, and moisture absorbency may degrade. Besides, the tension applied to the steel sheet decreases and the composite elastic modulus decreases, which might lead to iron loss degradation and especially iron loss degradation between before and after the roll reduction. Accordingly, in the case where the coating solution contains at least one additive selected from a titanium compound, a manganese sulfate, and an oxide colloid, such an additive is 10 parts to 50 parts by mass in terms of solid content with respect to 100 parts by mass of the phosphate.

Examples of the titanium compound include titanium lactate, titanium tetraacetylacetonate, titanium sulfate, and tetraacetic acid titanium. Examples of the oxide colloid include an antimony sol, a zirconia sol, and an iron oxide sol.

The coating solution may contain chromic anhydride or at least one dichromate selected from dichromates of Mg, Ca, Al, and Sr, instead of the above-mentioned additive. This enhances the corrosion resistance effectively. If the chromic anhydride or the dichromate is less than 10 parts by mass in terms of solid content with respect to 100 parts by mass of the phosphate, the tension applied to the steel sheet decreases and the composite elastic modulus decreases, which might lead to iron loss degradation and especially iron loss degradation between before and after the roll reduction. Besides, the corrosion resistance improving effect is insufficient. If the chromic anhydride or the dichromate is more than 50 parts by mass in terms of solid content with respect to 100 parts by mass of the phosphate, the tension applied to the steel sheet decreases and the composite elastic modulus decreases, which might lead to iron loss degradation and especially iron loss degradation between before and after the roll reduction. Besides, film formation is difficult, and moisture absorbency may degrade. Accordingly, in the case where the coating solution contains chromic anhydride or at least one dichromate selected from dichromates of Mg, Ca, Al, and Sr, the chromic anhydride or the dichromate is 10 parts to 50 parts by mass in terms of solid content with respect to 100 parts by mass of the phosphate.

The coating solution may further contain inorganic mineral particles such as silica or alumina, to improve the thermal resistance. In this case, the inorganic mineral particles such as silica or alumina are preferably 0.2 parts to 5.0 parts by mass in terms of solid content with respect to 100 parts by mass of the phosphate.

The coating amount of the coating (the coating amount per both sides) is preferably 7 g/m² to 16 g/m² after drying. If the coating amount of the coating is less than 7 g/m², it is difficult to ensure a predetermined coating film thickness, and the effect of keeping the steel sheet from the introduction of processing strain by absorbing, by the coating, stress applied during the roll reduction might decrease. If the coating amount of the coating is more than 16 g/m², the stacking factor might decrease.

After drying the applied coating solution, the grain-oriented electrical steel sheet is subjected to flattening annealing that also serves as coating baking. The flattening annealing conditions are described below.

Soaking temperature: 750° C. to 900° C.

If the soaking temperature is less than 750° C., the coating is not formed sufficiently, and the corrosion resistance and the magnetic property degrade. If the soaking temperature is more than 900° C., the composite elastic modulus of the coating is excessively high, which might cause an increase in the stress sensitivity of the steel sheet and lead to iron loss degradation between before and after the roll reduction. The soaking temperature is therefore in the range of 750° C. to 900° C.

Residence time in temperature range of 750° C. or more: 1 sec to 30 sec

The residence time in the temperature range of 750° C. or more in the flattening annealing (hereafter also simply referred to as “residence time”) needs to be 1 sec to 30 sec. This reduces the stress sensitivity of the steel sheet, and enables the steel sheet to maintain excellent magnetic property after processing even in the case where the steel sheet is subjected to strong roll reduction by the measuring rolls. If the residence time is less than 1 sec, the coating is not formed sufficiently, and not only the corrosion resistance degrades but also iron loss degradation between before and after the roll reduction ensues. If the residence time is more than 30 sec, the composite elastic modulus of the coating is excessively high, which causes an increase in the stress sensitivity of the steel sheet and leads to iron loss degradation between before and after the roll reduction. The residence time in the temperature range of 750° C. or more in the flattening annealing is therefore 1 sec to 30 sec. The residence time is preferably 2 sec or more. The residence time is preferably 25 sec or less. The residence time is more preferably 3 sec or more. The residence time is more preferably 20 sec or less.

Atmosphere in temperature range of 750° C. or more: inert atmosphere with dew point of 0° C. or less

The atmosphere in the temperature range of 750° C. or more may be any of N₂ gas, Ar gas, and the like, as long as it is an inert atmosphere. In terms of cost and safety, an atmosphere mainly made of N₂ gas is preferable. The atmosphere mainly made of N₂ gas is an atmosphere containing 50 vol % or more of N₂ gas. The inert atmosphere may contain 10 vol % or less of H₂ gas.

The dew point is set to 0° C. or less. If the dew point is more than 0° C., the composite elastic modulus of the coating is excessively high, which causes an increase in the stress sensitivity of the steel sheet and leads to iron loss degradation between before and after the roll reduction. No lower limit is placed on the dew point, but the lower limit is typically −60° C.

The conditions other than the above are not limited, and may follow conventional methods.

### EXAMPLES

### Example 1

A final-annealed grain-oriented electrical steel sheet (sheet thickness: 0.23 mm) produced according to a conventional method was prepared. The unreacted annealing separator was removed from the steel sheet, and the steel sheet was pickled with phosphoric acid. Each type of coating solution listed in Table 1 was then applied to the steel sheet on both sides so that the coating amount per both sides after drying was 10 g/m². After drying, flattening annealing also serving as baking was performed on the steel sheet. In the flattening annealing, the soaking temperature was 800° C., and the atmosphere in the temperature range of 750° C. or more was an inert atmosphere mainly made of N₂ gas (N₂ gas: 95 vol %), with a dew point of −1° C. The residence time in the temperature range of 750° C. or more was varied in the range of 0.5 sec to 40 sec as listed in Table 2.

Each grain-oriented electrical steel sheet obtained in this way was subjected to magnetic property measurement by the SST method. Moreover, the composite elastic modulus, film thickness, and applied tension of the coating formed on the steel sheet surface were measured. Here, the composite elastic modulus and applied tension of the coating were measured by the above-mentioned methods.

Each steel sheet was then roll-reduced at a linear pressure of 68.6 N/cm (7 kgf/cm). The steel sheet after the roll reduction was subjected again to magnetic property measurement by the SST method, and the change in iron loss was examined.

These results are listed in Table 2.

TABLE 1

| | | | | | | Blending | | Blending |
|---|---|---|---|---|---|---|---|---|
| Coating | | Blending | | Blending | Type of | quantity of | | quantity of |
| solution | | quantity of | | quantity of | chromium | chromium | Other | other |
| No. | Type of phosphate | colloidal silica* | Type of additive | additive* | compound | compound* | component | component* |
| 1 | Magnesium primary | 50 parts | — | — | Chromic | 20 parts | — | — |
| | phosphate | by mass | | | anhydride | by mass | | |
| 2 | Magnesium primary | 80 parts | — | — | Chromic | 20 parts | — | — |
| | phosphate | by mass | | | anhydride | by mass | | |
| 3 | Magnesium primary | 120 parts | — | — | Chromic | 20 parts | — | — |
| | phosphate | by mass | | | anhydride | by mass | | |
| 4 | Magnesium primary | 150 parts | — | — | Chromic | 20 parts | — | — |
| | phosphate | by mass | | | anhydride | by mass | | |
| 5 | Aluminum primary | 80 parts | — | — | Chromic | 10 parts | — | — |
| | phosphate | by mass | | | anhydride | by mass | | |
| 6 | Aluminum primary | 80 parts | — | — | Chromic | 20 parts | — | — |
| | phosphate | by mass | | | anhydride | by mass | | |
| 7 | Aluminum primary | 80 parts | — | — | Chromic | 50 parts | — | — |
| | phosphate | by mass | | | anhydride | by mass | | |
| 8 | Calcium primary | 80 parts | — | — | Magnesium | 20 parts | — | — |
| | phosphate | by mass | | | dichromate | by mass | | |
| 9 | Calcium primary | 80 parts | — | — | Aluminum | 20 parts | — | — |
| | phosphate | by mass | | | dichromate | by mass | | |
| 10 | Strontium primary | 80 parts | — | — | Calcium | 20 parts | — | — |
| | phosphate | by mass | | | dichromate | by mass | | |
| 11 | Strontium primary | 80 parts | — | — | Strontium | 20 parts | — | — |
| | phosphate | by mass | | | dichromate | by mass | | |
| 12 | Magnesium primary | 80 parts | Titanium | 20 parts | — | — | — | — |
| | phosphate | by mass | tetraacetylacetonate | by mass | | | | |
| 13 | Magnesium primary | 80 parts | Manganese sulfate | 20 parts | — | — | — | — |
| | phosphate | by mass | | by mass | | | | |
| 14 | Magnesium primary | 80 parts | Antimony sol | 20 parts | — | — | — | — |
| | phosphate | by mass | | by mass | | | | |
| 15 | Magnesium primary | 80 parts | Manganese sulfate | 20 parts | — | — | Silica | 0.3 parts |
| | phosphate | by mass | | by mass | | | powder | by mass |
| 16 | Magnesium primary | 80 parts | Manganese sulfate | 20 parts | — | — | Alumina | 3 parts |
| | phosphate | by mass | | by mass | | | powder | by mass |
| 17 | Magnesium primary | 180 parts | — | — | Chromic | 20 parts | — | — |
| | phosphate | by mass | | | anhydride | by mass | | |
| 18 | Magnesium primary | 40 parts | — | — | Chromic | 20 parts | — | — |
| | phosphate | by mass | | | anhydride | by mass | | |
| 19 | Aluminum primary | 50 parts | — | — | Chromic | 70 parts | — | — |
| | phosphate | by mass | | | anhydride | by mass | | |
| 20 | Aluminum primary | 80 parts | — | — | Chromic | 5 parts | — | — |
| | phosphate | by mass | | | anhydride | by mass | | |
| 21 | Aluminum primary | 80 parts | Titanium sulfate | 10 parts | — | — | — | — |
| | phosphate | by mass | | by mass | | | | |
| 22 | Aluminum primary | 80 parts | Tetraacetic acid | 50 parts | — | — | — | — |
| | phosphate | by mass | titanium | by mass | | | | |
| 23 | Aluminum primary | 80 parts | Zirconia sol | 10 parts | — | — | — | — |
| | phosphate | by mass | | by mass | | | | |
| 24 | Aluminum primary | 80 parts | Iron oxide sol | 50 parts | — | — | — | — |
| | phosphate | by mass | | by mass | | | | |

*blending quantity in terms of solid content with respect to 100 parts by mass of phosphate

TABLE 2

| | | | Coating | | | | |
|---|---|---|---|---|---|---|---|
| | | Residence time | Composite | Film | Applied | | |
| | Coating | at 750° C. or | elastic modulus | thickness | tension | ΔW_{17/50} | |
| No. | solution No. | more (sec) | (GPa) | (μm) | (MPa) | (W/kg) | Remarks |
| 1 | 1 | 3 | 78 | 2.2 | 8.7 | 0.004 | Example |
| 2 | 2 | 3 | 82 | 2.2 | 8.8 | 0.002 | Example |
| 3 | 3 | 3 | 89 | 2.1 | 9.1 | 0.000 | Example |
| 4 | 4 | 3 | 93 | 2.2 | 9.2 | 0.003 | Example |
| 5 | 5 | 3 | 68 | 2.3 | 7.4 | 0.007 | Example |
| 6 | 6 | 3 | 72 | 2.2 | 7.8 | 0.005 | Example |
| 7 | 7 | 3 | 75 | 2.3 | 8.3 | 0.004 | Example |
| 8 | 8 | 3 | 63 | 2.3 | 6.9 | 0.008 | Example |
| 9 | 9 | 3 | 67 | 2.3 | 7.4 | 0.006 | Example |
| 10 | 10 | 3 | 64 | 2.4 | 7.4 | 0.007 | Example |
| 11 | 11 | 3 | 61 | 2.3 | 6.2 | 0.008 | Example |
| 12 | 12 | 3 | 80 | 2.2 | 8.3 | 0.002 | Example |
| 13 | 13 | 3 | 79 | 2.2 | 8.2 | 0.003 | Example |
| 14 | 14 | 3 | 73 | 2.2 | 8.0 | 0.004 | Example |
| 15 | 15 | 3 | 77 | 2.1 | 8.3 | 0.003 | Example |
| 16 | 16 | 3 | 76 | 2.2 | 8.4 | 0.005 | Example |
| 17 | 17 | 3 | 98 | 2.2 | 9.0 | 0.011 | Comparative Example |
| 18 | 18 | 3 | 59 | 2.2 | 5.8 | 0.014 | Comparative Example |
| 19 | 19 | 3 | 57 | 2.1 | 5.6 | 0.017 | Comparative Example |
| 20 | 20 | 3 | 51 | 2.1 | 5.3 | 0.018 | Comparative Example |
| 21 | 1 | 0.5 | 48 | 2.2 | 3.2 | 0.024 | Comparative Example |
| 22 | 1 | 1 | 63 | 2.1 | 8.2 | 0.006 | Example |
| 23 | 1 | 10 | 71 | 2.1 | 8.6 | 0.001 | Example |
| 24 | 1 | 20 | 83 | 2.1 | 8.8 | 0.002 | Example |
| 25 | 1 | 30 | 88 | 2.1 | 8.9 | 0.004 | Example |
| 26 | 1 | 40 | 98 | 2.1 | 8.9 | 0.015 | Comparative Example |
| 27 | 21 | 3 | 66 | 2.3 | 6.7 | 0.000 | Example |
| 28 | 22 | 3 | 71 | 2.2 | 8.1 | 0.002 | Example |
| 29 | 23 | 3 | 67 | 2.3 | 7.3 | 0.003 | Example |
| 30 | 24 | 3 | 73 | 2.1 | 8.0 | 0.001 | Example |
| 31 | 5 | 0.5 | 58 | 2.5 | 7.0 | 0.012 | Comparative Example |
| 32 | 4 | 0.5 | 70 | 2.0 | 5.9 | 0.011 | Comparative Example |

It can be understood from Table 2 that, in all Examples, the amount of iron loss degradation between before and after the roll reduction was 0.010 W/kg or less in W_{17/50}, and magnetic property degradation caused by the roll reduction was effectively suppressed.

### Example 2

A final-annealed grain-oriented electrical steel sheet same as that in Example 1 was prepared. The unreacted annealing separator was removed from the steel sheet, and the steel sheet was pickled with phosphoric acid. The coating solution No. 12 in Table 1 was then applied to the steel sheet on both sides so that the coating amount per both sides after drying was 15 g/m². After drying, flattening annealing also serving as baking was performed on the steel sheet under the conditions listed in Table 3, with the atmosphere in the temperature range of 750° C. or more being an inert atmosphere mainly made of N₂ gas (N₂ gas: 99 vol %).

Each grain-oriented electrical steel sheet obtained in this way was subjected to magnetic property measurement by the SST method. Moreover, the composite elastic modulus, film thickness, and applied tension of the coating formed on the steel sheet surface were measured. Here, the composite elastic modulus and applied tension of the coating were measured by the above-mentioned methods.

Each steel sheet was then roll-reduced at a linear pressure of 68.6 N/cm (7 kgf/cm). The steel sheet after the roll reduction was subjected again to magnetic property measurement by the SST method, and the change in iron loss was examined.

These results are listed in Table 3.

TABLE 3

| | | | | Coating | | | | |
|---|---|---|---|---|---|---|---|---|
| | Soaking | Residence time | Atmosphere | Composite | Film | Applied | | |
| | temperature | at 750° C. or | dew point | elastic modulus | thickness | tension | ΔW_{17/50} | |
| No. | (° C.) | more (sec) | (° C.) | (GPa) | (μm) | (MPa) | (W/kg) | Remarks |
| 1 | 720 | 0 | −20 | 53 | 2.7 | 4.1 | 0.015 | Comparative Example |
| 2 | 750 | 3 | −20 | 70 | 2.6 | 9.5 | 0.006 | Example |
| 3 | 770 | 3 | −20 | 76 | 2.6 | 10.3 | 0.006 | Example |
| 4 | 800 | 3 | −20 | 81 | 2.6 | 11.0 | 0.004 | Example |
| 5 | 850 | 3 | −20 | 87 | 2.6 | 11.5 | 0.005 | Example |
| 6 | 900 | 3 | −20 | 94 | 2.6 | 11.9 | 0.009 | Example |
| 7 | 950 | 3 | −20 | 101 | 2.6 | 12.1 | 0.012 | Comparative Example |
| 8 | 820 | 0.8 | −20 | 57 | 2.6 | 5.9 | 0.011 | Comparative Example |
| 9 | 820 | 2 | −20 | 62 | 2.6 | 9.4 | 0.007 | Example |
| 10 | 820 | 10 | −20 | 79 | 2.6 | 10.5 | 0.002 | Example |
| 11 | 820 | 20 | −20 | 85 | 2.6 | 10.7 | 0.001 | Example |
| 12 | 820 | 30 | −20 | 92 | 2.5 | 11.3 | 0.009 | Example |
| 13 | 820 | 35 | −20 | 96 | 2.4 | 11.4 | 0.011 | Comparative Example |
| 14 | 820 | 5 | −20 | 83 | 2.6 | 9.8 | 0.003 | Example |
| 15 | 820 | 5 | −10 | 85 | 2.6 | 10.4 | 0.004 | Example |
| 16 | 820 | 5 | −5 | 88 | 2.6 | 10.8 | 0.006 | Example |
| 17 | 820 | 5 | −1 | 91 | 2.6 | 11.2 | 0.008 | Example |
| 18 | 820 | 5 | 0 | 95 | 2.5 | 11.6 | 0.009 | Example |
| 19 | 820 | 5 | 2 | 99 | 2.5 | 11.8 | 0.012 | Comparative Example |
| 20 | 820 | 5 | 5 | 102 | 2.5 | 11.9 | 0.013 | Comparative Example |
| 21 | 920 | 0.8 | −20 | 59 | 2.7 | 7.1 | 0.011 | Comparative Example |
| 22 | 720 | 10 | 2 | 71 | 2.3 | 5.8 | 0.011 | Comparative Example |

It can be understood from Table 3 that, in all Examples, the amount of iron loss degradation between before and after the roll reduction was 0.010 W/kg or less in W_{17/50}, and magnetic property degradation caused by the roll reduction was suppressed.

1. A grain-oriented electrical steel sheet having a coating on a surface thereof,
wherein the coating has a composite elastic modulus of 60 GPa to 95 GPa and a film thickness of 1.0 μm or more, and a tension applied to the grain-oriented electrical steel sheet by the coating is 6.0 MPa or more, and
an amount of iron loss degradation between before and after roll reduction when the grain-oriented electrical steel sheet is roll-reduced at a linear pressure of 68.6 N/cm is 0.010 W/kg or less in W_{17/50}.

2. A manufacturing method for the grain-oriented electrical steel sheet according to claim 1, the manufacturing method comprising:
applying a coating solution to a final-annealed grain-oriented electrical steel sheet; and
performing flattening annealing that also serves as coating baking, on the final-annealed grain-oriented electrical steel sheet to which the coating solution is applied,
wherein the coating solution contains at least one phosphate selected from phosphates of Mg, Al, Ca, and Sr, and contains 50 parts to 150 parts by mass of colloidal silica in terms of solid content with respect to 100 parts by mass of the phosphate, and
in the flattening annealing, a soaking temperature is set to 750° C. to 900° C., a residence time in a temperature range of 750° C. or more is set to 1 sec to 30 sec, and an atmosphere in the temperature range is set to an inert atmosphere with a dew point of 0° C. or less.

3. The manufacturing method according to claim 2,
wherein the coating solution further contains 10 parts to 50 parts by mass in total of at least one additive selected from a titanium compound, a manganese sulfate, and an oxide colloid in terms of solid content, with respect to 100 parts by mass of the phosphate.

4. The manufacturing method according to claim 2,
wherein the coating solution further contains 10 parts to 50 parts by mass of chromic anhydride in terms of solid content or 10 parts to 50 parts by mass in total of at least one dichromate selected from dichromates of Mg, Ca, Al, and Sr in terms of solid content, with respect to 100 parts by mass of the phosphate.
